(19) United States
(12) Patent Application Publication
(10) Pub. No.: US 2025/0038922 A1
(43) Pub. Date: Jan. 30, 2025

(54) METHOD FOR SENDING POSITIONING REFERENCE SIGNAL, TERMINAL, AND NETWORK DEVICE

(71) Applicant: GUANGDONG OPPO MOBILE TELECOMMUNICATIONS CORP., LTD., Dongguan (CN)

(72) Inventors: Shichang ZHANG, Dongguan (CN); Zhenshan ZHAO, Dongguan (CN)

(21) Appl. No.: 18/919,003

(22) Filed: Oct. 17, 2024

Related U.S. Application Data
(63) Continuation of application No. PCT/CN2022/088851, filed on Apr. 24, 2022.

(51) Int. Cl. H04L 5/00; H04W 72/40

(52) U.S. Cl. CPC H04L 5/0051; H04W 72/40

(57) ABSTRACT

Provided is a method for sending a positioning reference signal (PRS), applicable to a first terminal. The method includes: sending a first-type sidelink PRS (SL-PRS) or a second-type SL-PRS, wherein the first-type SL-PRS is an SL-PRS separately sent, and the second-type SL-PRS is an SL-PRS associated with a physical sidelink control channel (PSCCH)/physical sidelink shared channel (PSSCH).

### CROSS-REFERENCE TO RELATED APPLICATION

This application is a continuation of International Application No. PCT/CN2022/088851, filed Apr. 24, 2022, the entire disclosure of which is incorporated herein by reference.

### TECHNICAL FIELD

The present disclosure relates to the field of sidelink (SL) communication, and in particular, to a method and apparatus for sending a positioning reference signal (PRS), a device, and a medium.

### BACKGROUND

During SL communication, to support SL-based positioning, a terminal needs to send a PRS on an SL. In the related art, no feasible solution is currently available for a terminal to send an SL-PRS under what conditions.

### SUMMARY

The embodiments of the present disclosure provide a method for sending a PRS, a terminal, and network device.

According to some embodiments of the present disclosure, a method for sending a PRS is provided. The method includes:
sending a first-type SL-PRS or a second-type SL-PRS, wherein the first-type SL-PRS is an SL-PRS separately sent, and the second-type SL-PRS is an SL-PRS associated with a physical sidelink control channel (PSCCH)/physical sidelink shared channel (PSSCH).

According to some embodiments of the present disclosure, a method for sending a PRS is provided. The method includes:
sending first trigger signaling to a first terminal, wherein the first trigger signaling is used to trigger the first terminal to send a first-type SL-PRS or a second-type SL-PRS.

According to some embodiments of the present disclosure, a first terminal is provided. The terminal includes a processor; a transceiver connected to the processor, and a memory configured to store one or more instructions executable by the processor. The processor, when loading and running the one or more instructions, is caused to perform the method for sending the PRS according to the foregoing embodiments.

According to some embodiments of the present disclosure, a network device is provided. The network device includes a processor; a transceiver connected to the processor; and a memory configured to store one or more instructions executable by the processor. The processor, when loading and running the one or more instructions, is caused to perform the method for sending the PRS according to the foregoing embodiments.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a working scenario of SL transmission in the related art;

FIG. 2 is a schematic diagram of a working scenario of SL transmission in the related art;

FIG. 3 is a schematic diagram of a working scenario of SL transmission in the related art;

FIG. 4 is a schematic diagram of a working scenario of SL transmission in the related art;

FIG. 5 is a schematic diagram of a working scenario of SL transmission in the related art;

FIG. 6 is a schematic diagram of a working scenario of SL transmission in the related art;

FIG. 7 is a schematic diagram of some symbols in a slot used for SL transmission in the related art;

FIG. 8 is a schematic structural diagram of a PSCCH and PSSCH slot in the related art;

FIG. 9 is a schematic diagram of time domain positions of 4 DMRS symbols for 13 PSSCH symbols in the related art;

FIG. 10 is a schematic diagram of a frequency domain position of a PSSCH DMRS in the related art;

FIG. 11 is a schematic diagram of a method for sending a positioning reference signal according to some embodiments of the present disclosure;

FIG. 12 is a schematic diagram of a method for sending a positioning reference signal according to some embodiments of the present disclosure;

FIG. 13 is a schematic diagram of a method for sending a positioning reference signal according to some embodiments of the present disclosure;

FIG. 14 is a schematic diagram of a method for sending a positioning reference signal according to some embodiments of the present disclosure;

FIG. 15 is a schematic diagram of a method for sending a positioning reference signal according to some embodiments of the present disclosure;

FIG. 16 is a schematic diagram of a method for sending a positioning reference signal according to some embodiments of the present disclosure;

FIG. 17 is a schematic diagram of a method for sending a positioning reference signal according to some embodiments of the present disclosure;

FIG. 18 is a schematic diagram of a method for sending a positioning reference signal according to some embodiments of the present disclosure;

FIG. 19 is a schematic diagram of a method for sending a positioning reference signal according to some embodiments of the present disclosure;

FIG. 20 is a schematic diagram of a method for sending a positioning reference signal according to some embodiments of the present disclosure;

FIG. 21 is a schematic diagram of a method for sending a positioning reference signal according to some embodiments of the present disclosure;

FIG. 22 is a structural block diagram of an apparatus for sending a positioning reference signal according to some embodiments of the present disclosure;

FIG. 23 is a structural block diagram of another apparatus for sending a positioning reference signal according to some embodiments of the present disclosure;

FIG. 24 is a structural block diagram of another apparatus for sending a positioning reference signal according to some embodiments of the present disclosure; and

FIG. 25 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings. Illustrative embodiments are described herein in detail and illustrated in the accompanying drawings. In the case that the following description relates to the accompanying drawings, the same numerals in different accompanying drawings indicate the same or similar elements unless otherwise indicated. The implementations described in the following illustrative embodiments do not represent all embodiments consistent with the present disclosure. Rather, these illustrative embodiments are only examples of apparatuses and methods consistent with some aspects of the disclosure or as detailed in the appended claims.

The terms in the present disclosure are used only for the purpose of describing particular embodiments but are not intended to limit the present disclosure. The singular forms of “a,” “said,” and “the” as used in the present disclosure and the appended claims are also intended to encompass the plural form, unless the context indicates a different meaning. It should also be understood that the phrase “and/or” as used herein refers to and encompasses any or all possible combinations of one or more of the associated listed items.

It should be understood that even the terms “first,” “second,” “third,” and the like may be used in the present disclosure to describe various pieces of information, such information should not be limited by these terms. These terms are used only to distinguish the same type of information. In some embodiments, without departing from scope of the present disclosure, first information may be referred to as second information in some embodiments, and similarly, second information may be referred to as first information in some embodiments. Depending on the context, as used herein, a phrase “if” is interpreted as “in the case that . . . ,” “when . . . ,” or “in response to determining . . . ”.

In the embodiments of the present disclosure, the term “and/or” is only a description of the association relationship of the associated objects, indicating that there may be three relationships. For example, the phrase “A and/or B” means (A), (B), or (A and B). In addition, the character “/” in this article generally indicates that the associated objects before and after are in an “or” relationship.

First, the relevant technical background involved in the embodiments of the present disclosure is described.

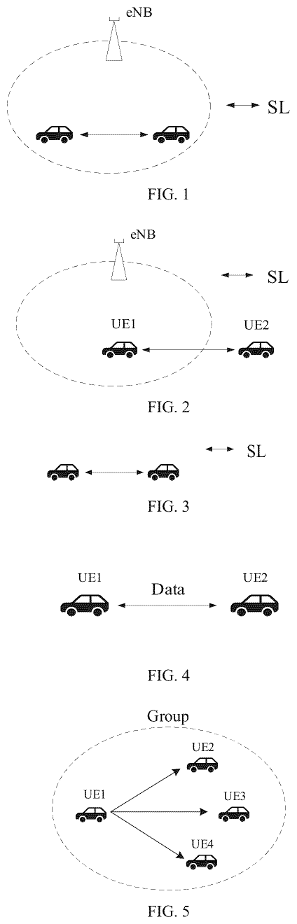

Depending on a network coverage situation of an end user equipment (UE) that conducts communications, the sidelink communications are categorized into a network coverage sidelink communication, a partial network coverage sidelink communication, and a sidelink communication out of network coverage as illustrated in FIG. 1, FIG. 2, and FIG. 3, respectively.

As illustrated in FIG. 1, in the network coverage sidelink communication, all terminals performing sidelink communications are within the coverage region of the same base station, such that all of the above terminals perform sidelink communications based on the same sidelink configuration by receiving configuration signaling from the base station. As illustrated in FIG. 2, in the partial network coverage sidelink communication, some of the terminals performing sidelink communications are within the coverage region of the base station, and these terminals are capable of receiving the configuration signaling from the base station and perform sidelink communications based on the configuration from the base station. The terminals located outside the network coverage cannot receive the configuration signaling from the base station, therefore the terminals located outside the network coverage determine sidelink configuration and perform sidelink communications based on pre-configuration information and information carried in the physical sidelink broadcast channel (PSBCH) transmitted by the terminal within the network coverage. As illustrated in FIG. 3, with respect to the sidelink communication out of network coverage, all terminals that perform the sidelink communications are outside the network coverage, and all terminals determine the sidelink configuration and perform the sidelink communications based on the pre-configuration information.

### Device to Device (D2D)/Vehicle to Everything (V2X):

The Device to Device communication is a sidelink (SL) transmission technology based on the D2D, which is different from the traditional cellular system in which communication data is received or transmitted over a base station, and thus has higher spectral efficiency and lower transmission delay. The Vehicle to Everything systems adopt a direct terminal-to-terminal communication, and two transmission modes are defined in 3^{rd} generation partnership project (3GPP): a first mode and a second mode.

The first mode: a transmission resource of a terminal is allocated by a base station, and the terminal transmits data on the sidelink based on the resource allocated by the base station. The base station is capable of allocating the resource of a single transmission for the terminal, or allocating the resource of a semi-static transmission for the terminal. As illustrated in FIG. 1, the terminal is within the network coverage, and the network allocates the transmission resource of the sidelink transmission for the terminal.

The second mode: the terminal selects a resource within a resource pool for data transmission. As illustrated in FIG. 3, the terminal is outside a cell coverage, and the terminal autonomously selects a transmission resource within a preconfigured resource pool for sidelink transmission; or as illustrated in FIG. 1, the terminal autonomously selects a transmission resource within a resource pool configured by the network for a sidelink transmission.

The resource selection under the second mode includes the following two processes.

Process 1: The terminal takes all available resources in a resource selection window as a resource set A.

In the case that the terminal transmits data in some slots within a sensing window without sensing, all resources on slots, corresponding to the slots within the sensing window, within a selection window are excluded. The terminal determines the corresponding slots within the selection window based on a set of values of a resource reservation period field in a resource pool configuration used by the terminal.

In the case that the terminal senses a physical sidelink control channel (PSCCH) within the sensing window, a reference signal received power (RSRP) of the PSCCH or an RSRP of a physical sidelink shared channel (PSSCH) scheduled by the PSCCH is measured. In the case that the measured RSRP is greater than an SL-RSRP threshold, and it is determined, based on resource reservation information in the sidelink control information transmitted in the PSCCH, that the reserved resource indicated by the resource reservation information is within the resource selection window, then the resource corresponding the resource reservation information is excluded from the resource set A. In the case that the remaining resource in the resource set A is less than X % of all the resources in the resource set A prior to the resource exclusion being performed on the resource set A, the SL-RSRP threshold is increased by 3 dB, and the process 1 is performed again. The possible values of the above X are {20, 35, 50}, and the terminal determines the parameter X from the set of values based on a priority of the data to be transmitted. At the same time, the above SL-RSRP threshold is related to a priority carried in the PSCCH that is sensed by the terminal and a priority of the data to be transmitted by the terminal. The terminal takes the remaining resource in the set A upon the resource exclusion as a candidate resource set.

Process 2: The terminal randomly selects a number of resources from the candidate resource set as the transmission resources of an initial transmission and retransmission of the terminal.

### New Radio (NR)-V2X:

In the NR-V2X, automatic driving needs to be supported, and therefore higher requirements are imposed on data interaction between vehicles, such as higher throughput, lower latency, higher reliability, larger coverage, and more flexible resource allocation.

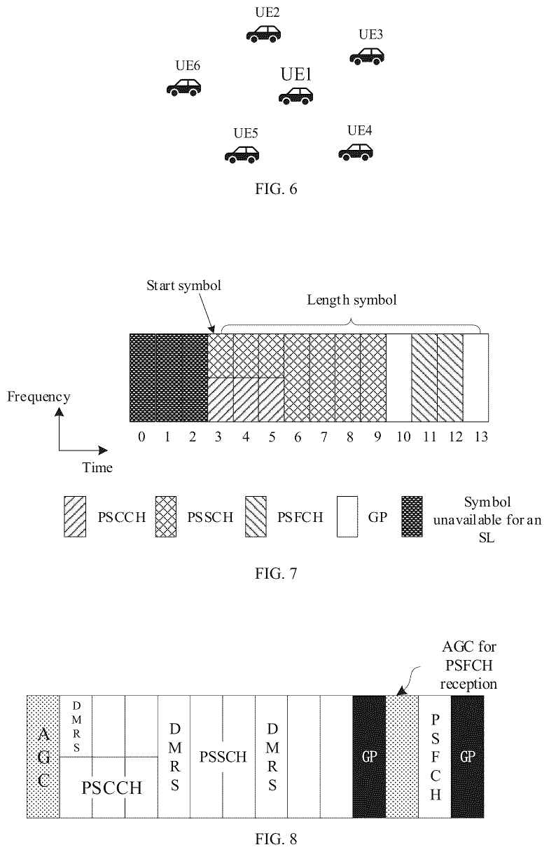

In long-term evolution (LTE)-V2X, broadcast transmission mode is supported, and in the NR-V2X, unicast and multicast transmission modes are introduced. For the unicast transmission, a receiver terminal includes only one terminal. As illustrated in FIG. 4, the unicast transmission is performed between UE 1 and UE 2. For multicast transmission, the receiver terminal includes all terminals within a communication group or all terminals within a specific transmission distance. As illustrated in FIG. 5, UE 1, UE 2, UE 3, and UE 4 constitute a communication group, in which the UE 1 transmits data, and all the other terminal devices in the group are receiver terminals. For the broadcast transmission mode, the receiver terminal includes any terminal around the transmitter terminal. As illustrated in FIG. 6, UE 1 is the transmitter terminal, and the other terminals around UE 1: UE 2, UE 3, UE 4, UE 5, and UE 6 are all receiver terminals.

### Slot Structure in NR-V2X:

In the NR-V2X, the PSSCH and the PSCCH associated with the PSSCH are transmitted in the same slot, and the PSCCH occupies two or three time domain symbols. The time domain resources in the NR-V2X are allocated by taking the slot as the allocation granularity. The start point and length of the time domain symbols for the sidelink transmission in one slot are configured by the parameters sidelink start symbols (SL-StartSymbols) and sidelink length symbols (SL-LengthSymbols). The last symbol in the time domain symbols is used as a guard period (GP), and only the rest of the time domain symbols are available for the PSSCH and PSCCH. However, in the case that one slot is configured with a physical sidelink feedback channel (PSFCH) transmission resource, the PSSCH and PSCCH cannot occupy the time domain symbols configured for the PSFCH transmission, as well as an automatic gain control (AGC) symbol and the GP symbol before the symbols configured for the PSFCH transmission.

As illustrated in FIG. 7, the network configures SL-StartSymbols=3 and SL-LengthSymbols=11, i.e., 11 time domain symbols starting from symbol index 3 (symbols 3 to 13) are available for the sidelink transmission in one slot. The slot has the resource of the PSFCH transmission, which occupies symbols 11 and 12, with the symbol 11 serving as the AGC symbol of the PSFCH, and symbols 10 and 13 serving as GPs. The time domain symbols that are available for the PSSCH transmission are symbols 3 to 9, and the PSCCH occupies three time domain symbols, i.e., symbols 3, 4, and 5, with the symbol 3 serving as the AGC symbol.

In addition to the PSCCH and the PSSCH, the PSFCH is also possible within one sidelink slot in the NR-V2X, as illustrated in FIG. 8. It can be seen that within one slot, a 1^{st} orthogonal frequency division multiplexing (OFDM) symbol is fixed to be configured for AGC, and on the AGC symbol, the UE replicates information transmitted on a 2^{nd} symbol. One symbol is reserved at the end of the slot for switching transmitting and receiving, which is configured for the UE to switch from a transmitting (or receiving) state to a receiving (or transmitting) state. Among the remaining OFDM symbols, the PSCCH is capable of occupying two or three OFDM symbols starting from the 2^{nd} sidelink symbol, and in the frequency domain, the number of physical resource blocks (PRBs) occupied by the PSCCH is within a sub-band of one PSSCH. In the case that the number of PRBs occupied by the PSCCH is less than a size of a sub-channel of the PSSCH, or, the frequency domain resources of the PSSCH include multiple sub-channels, then the PSCCH can be frequency division multiplexed with the PSSCH on the OFDM symbol where the PSCCH is located.

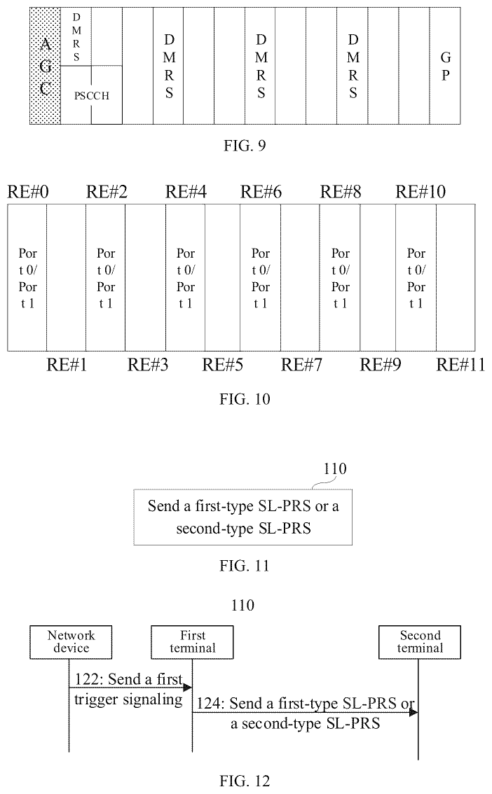

The demodulation reference signal (DMRS) symbol for the PSSCH in the NR-V2X draws on the design of User-Equipment universal terrestrial radio access network (UTRAN) (Uu) interface, which employs a plurality of time domain PSSCH DMRS patterns. The number of DMRS patterns that are available within one resource pool is related to the number of PSSCH symbols within the resource pool. For a specific number of PSSCH symbols (including the 1^{st} AGC symbol) and a specific number of PSCCH symbols, the available DMRS patterns and the position of each DMRS symbol within the pattern are illustrated in Table 1. A schematic of the time domain locations of four DMRS symbol in the case that the number of PSSCH symbols is thirteen is illustrated in FIG. 9.

TABLE 1
Number and location of DMRS symbols with
different PSSCH and PSCCH symbol numbers

| | Locations of DMRS symbols | | | | | |
|---|---|---|---|---|---|---|
| Number of | (relative to the location of the 1^{st} AGC symbol) | | | | | |
| PSSCH symbols | Number of PSCCH | | | Number of PSCCH | | |
| (including | symbols being 2 | | | symbols being 3 | | |
| the 1^{st} AGC | Number of DMRS symbols | | | Number of DMRS symbols | | |
| symbol) | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 3 | 3, 10 | 1, 6, 11 | 1, 4, 7, 10 | 4, 10 | 1, 6, 11 | 1, 4, 7, 10 |

In the case that the plurality of time domain DMRS patterns are configured in the resource pool, the specific time domain DMRS pattern to be adopted is selected by a transmit UE and indicated in first-stage sidelink control information (SCI). Such a design allows a high density DMRS pattern to be selected by a UE with high speed motion, thereby ensuring an accuracy of channel estimation; whereas for a UE with low speed motion, a low density DMRS pattern is adopted, thereby improving the spectral efficiency.

The generation of the PSSCH DMRS sequence is almost same to the generation of the PSCCH DMRS sequence, and the only difference lies in: N_{1D}=Σᵢ₌₀^{L-1}pᵢ·2^{L-1-i} in an initialization formula Cᵢₙᵢₜ of a pseudo-random sequence c(m), wherein pᵢ represents an i^{th} bit of cyclic redundancy check (CRC) of the PSCCH scheduling the PSSCH, and L=24, representing the number of bits of PSCCH CRC.

Two frequency domain DMRS patterns, i.e., DMRS frequency domain type 1 and DMRS frequency domain type 2, are supported in the NR physical downlink shared channel (PDSCH) and physical uplink shared channel (PUSCH), and for each of the frequency domain types, there are two different types of single DMRS symbol and dual DMRS symbols. The single-symbol DMRS frequency domain type 1 supports four DMRS ports, the single-symbol DMRS frequency domain type 2 supports six DMRS ports, and the number of supported ports is doubled in both cases of dual DMRS symbols. However, in the NR-V2X, only single-symbol DMRS frequency domain type 1 is supported, as illustrated in FIG. 10, because the PSSCH needs to support at most two DMRS ports.

### Positioning Based on the Sidelink:

The positioning based on the sidelink is one of improved schemes of R18 positioning technology. In this topic, the scenarios and requirements to support NR positioning application cases in-coverage, partial-coverage, and out-of-coverage of cellular networks are considered, and the positioning requirements of V2X application cases, public safety application cases, commercial application cases, and industrial Internet of things (HOT) application cases are considered. Further, supports for the following functions are considered:
absolute positioning, ranging/direction measurement, and relative positioning;
investigating a positioning method based on the combination of sidelink measurement results and Uu interface measurement results;
investigating sidelink positioning reference signals, including signal design, physical layer control signaling, resource allocation, physical layer measurement results, and associated physical layer processes, or the like; and
investigating a positioning system architecture and signaling processes, such as configuration, measurement, and reporting, etc.

It should be understood that in some embodiments of the present disclosure, “NR” is also referred to as a 5^{th} generation mobile communication technology (5G) NR system or a 5G system. The technical solutions according to some embodiments of the present disclosure are applicable to the 5G NR system, subsequent evolved systems of the 5G NR system, or 6^{th} generation mobile communication technology (6G) and subsequent evolved systems.

FIG. 11 is a flowchart of a method for sending a PRS according to some embodiments of the present disclosure. An example in which the method is applied to a terminal is used for description in these embodiments. The method includes at least one of the following processes.

In process 110, a first terminal sends a first-type sidelink PRS (SL-PRS) or a second-type SL-PRS.

The first-type SL-PRS is an SL-PRS separately sent. The first-type SL-PRS sent by the terminal is used to support relative positioning. The separately sent SL-PRS is not associated with a PSCCH and/or PSSCH. That is, the terminal does not need to receive the SL-PRS as indicated by the PSCCH and/or PSSCH. Relative positioning is positioning performed to obtain an offset from a reference location. The reference location is an original location of the terminal or a location of a reference point.

The second-type SL-PRS is associated with the PSCCH and/or PSSCH. That is, the terminal needs to receive the SL-PRS as indicated by the PSCCH and/or PSSCH. The second-type SL-PRS sent by the terminal is used to support absolute positioning. Absolute positioning is positioning performed to obtain a specific geographical location, such as latitude and longitude. The PSCCH and/or PSSCH associated with the SL-PRS carries information related to the SL-PRS, such as a transmission angle, transmission time, period, and displacement of the SL-PRS.

The first-type SL-PRS and the second-type SL-PRS are distinguished by at least different resources. The resources include at least one of time domain, frequency domain, and code domain resources. For example, two different types of SL-PRSs are sent in different resource pools configured or preconfigured by a base station, on different time-frequency resources in the same resource pool, or on the same time-frequency resource in the same resource pool in different sequences (namely different code domain resources). That is, the first-type SL-PRS and the second-type SL-PRS use different transmission resources, or the first-type SL-PRS and the second-type SL-PRS correspond to different resource pools.

In some embodiments, the first terminal sends the first-type SL-PRS or the second-type SL-PRS based on a trigger of a network device, for example, based on first trigger signaling from the network device. Optionally, the first terminal stops sending the first-type SL-PRS or the second-type SL-PRS based on the trigger of the network device, for example, based on second trigger signaling from the network device. Optionally, the first terminal stops sending the first-type SL-PRS or the second-type SL-PRS in the case that a stopping condition is satisfied, such as the first terminal being beyond a valid geographical range and/or exceeding a validity period.

In some embodiments, the first terminal sends the first-type SL-PRS or the second-type SL-PRS based on a trigger of an SL, for example, based on third trigger signaling from the SL. Optionally, the first terminal stops sending the first-type SL-PRS or the second-type SL-PRS in the case that the third trigger signaling is not received again within a target duration. Optionally, the first terminal stops sending the first-type SL-PRS or the second-type SL-PRS in the case that the third trigger signaling is received again within the target duration and a received signal quality of the third trigger signaling is lower than a threshold. Optionally, the first terminal stops sending the first-type SL-PRS or the second-type SL-PRS in the case that fourth trigger signaling is received from the SL.

In some embodiments, the first terminal sends the first-type SL-PRS or the second-type SL-PRS based on an autonomous trigger, for example, in the case that a trigger condition is satisfied. Optionally, the first terminal stops sending the first-type SL-PRS or the second-type SL-PRS in the case that the trigger condition is not satisfied.

In some embodiments, the first terminal is a transmitter terminal and/or the first terminal is a receiver terminal.

In some embodiments, the first terminal is in a unicast SL communication scenario, a multicast SL communication scenario, or a broadcast SL communication scenario.

In some embodiments, the first terminal sends only the first-type SL-PRS or the second-type SL-PRS, or the first terminal sends both the first-type and second-type SL-PRSs.

The foregoing method is applicable to an SL communication scenario based on a first mode and/or an SL communication scenario based on a second mode.

In some embodiments, the foregoing sending methods are used alone or in combination.

In summary, the method for flexibly sending a PRS is provided in the method according to these embodiments, different types of PRSs are sent under different SL communication conditions during SL communication, thereby improving positioning accuracy on the SL.

Manners of sending a PRS provided in the present disclosure are classified into at least three types:

Type 1: Based on a trigger of a network device.

Type 2: Based on a trigger of an SL.

Type 3: Based on an autonomous trigger.

Type 1: A first-type SL-PRS or a second-type SL-PRS is sent based on a trigger of a network device.

FIG. 12 is a schematic diagram of a method for sending a PRS according to some embodiments of the present disclosure. An example in which the method is applied to a terminal is used for description in these embodiments. The method includes at least one of the following processes.

In process 122, a network device sends a first trigger signaling to a first terminal.

The first trigger signaling is used to trigger the first terminal to send a first-type SL-PRS or a second-type SL-PRS, and is sent by the network device to the first terminal.

In some embodiments, the first trigger signaling is indicated explicitly, such as direct signaling. The network device sends first configuration information before sending the explicitly indicated first trigger signaling. The first configuration information is used to configure at least one of a transmission resource or a transmission parameter of the SL-PRS.

The transmission resource includes at least one type of a time domain resource, frequency domain resource, code domain resource, or the like.

The transmission parameter includes at least one of a transmission quantity, transmission period, transmission resource quantity, transmission time, transmission interval, or the like.

In some embodiments, the first trigger signaling is indicated implicitly, namely first configuration information. The first configuration information is used to configure at least one of a transmission resource or a transmission parameter of the SL-PRS.

In process 124, the first terminal sends the first-type SL-PRS or the second-type SL-PRS.

The first terminal sends the first-type SL-PRS or the second-type SL-PRS based on the first trigger signaling from the network device.

In some embodiments, the network device sends the explicitly indicated first trigger signaling to the first terminal. Before sending the first trigger signaling, the network device sends the first configuration information to the first terminal. The first terminal triggers sending of the first-type SL-PRS or the second-type SL-PRS based on the first trigger signaling. The first terminal sends the first-type SL-PRS or the second-type SL-PRS based on the transmission resource and/or the transmission parameter indicated by the first configuration information.

In some embodiments, the network device sends the implicitly indicated first trigger signaling to the first terminal. The first trigger signaling is the first configuration information. The terminal triggers sending of the first-type SL-PRS or the second-type SL-PRS upon receiving the first configuration information. The first terminal sends the first-type SL-PRS or the second-type SL-PRS based on the transmission resource and/or the transmission parameter indicated by the first configuration information.

In some embodiments, the first terminal sends the first-type SL-PRS or the second-type SL-PRS; or the first terminal sends both the first-type and second-type SL-PRSs.

In summary, the terminal sends different PRSs based on a trigger of the network device in the method according to these embodiments, which satisfies positioning requirements under different conditions during SL communication and improves positioning accuracy on the SL.

Some embodiments for reporting assistance information to a network device are given as follows,

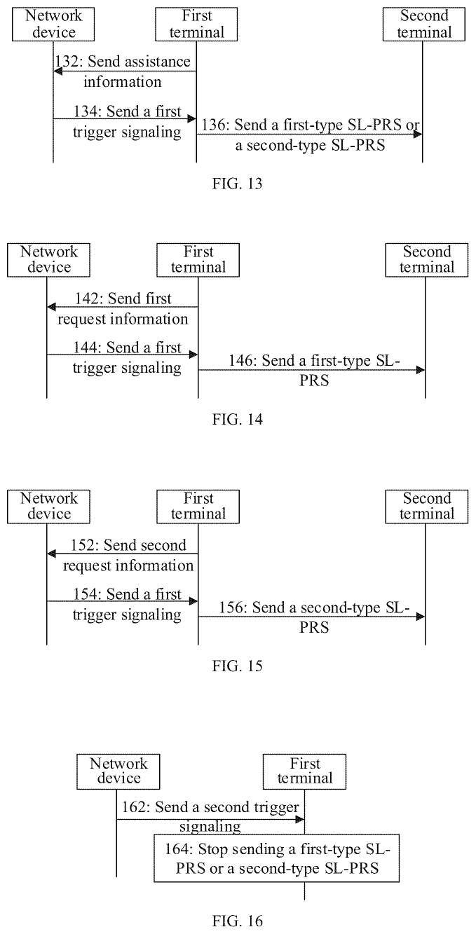

FIG. 13 is a schematic diagram of a method for sending a PRS according to some embodiments of the present disclosure. An example in which the method is applied to a terminal is used for description in these embodiments. The method includes at least one of the following processes.

In process 132, a first terminal sends assistance information to a network device.

The assistance information is used to assist the network device in deciding whether to send a first trigger signaling, and is sent by the first terminal to the network device.

In some embodiments, the assistance information includes at least one of the following:

### —Geographical Location Information of the First Terminal

The geographical location information includes a specific geographical location of the first terminal, such as latitude and longitude; or a relative location of the first terminal, such as an offset from a reference location. The reference location is an original location of the first terminal or a location of a reference point.

### —Type Information of the First Terminal

Terminal types include a first-type terminal, such as a roadside unit (RSU), a terminal that requires relative location information of another controlled device, and a terminal matched with an interactive input device; and
a second-type terminal, such as an on-board unit, a handheld unit, a controlled device that needs to report relative location information, and an interactive input device.

In some embodiments, the first terminal reports the assistance information based on a configuration or a requirement. For example, the first terminal periodically reports the assistance information based on the configuration. Optionally, the configuration is predefined, configured by the network device for the first terminal, autonomously configured by the first terminal, or configured by a second terminal for the first terminal over an SL. Optionally, the period is fixed, configured by the network device, autonomously determined by the first terminal, or configured by the second terminal over the SL. For example, the first terminal reports the assistance information based on the requirement. Optionally, the requirement is predefined, from the network device, or from the SL.

In process 134, the network device sends the first trigger signaling to the first terminal in the case that a trigger condition is satisfied.

The network device decides, based on the assistance information, whether to send the first trigger signaling to the first terminal.

In some embodiments, the network device sends the first trigger signaling to the first terminal in the case that the assistance information from the first terminal satisfies the trigger condition.

In some embodiments, the first trigger signaling is indicated explicitly, such as first configuration information. The first configuration information is used to configure at least one of a transmission resource or a transmission parameter of a first-type SL-PRS or a second-type SL-PRS.

In some embodiments, the first trigger signaling is indicated implicitly. For example, the first trigger signaling further carries first configuration information. The first configuration information is used to configure at least one of a transmission resource or a transmission parameter of a first-type SL-PRS or a second-type SL-PRS.

In some embodiments, the assistance information includes the geographical location information of the first terminal. The network device sends the first trigger signaling to the first terminal in the case that the geographical location of the first terminal falls within a target range. The target range includes a zone not covered by a global navigation satellite system (GNSS) and/or not covered by a cellular network that satisfies a positioning requirement.

In some embodiments, the assistance information includes the type information of the first terminal. The network device sends the first trigger signaling to the first terminal in the case that the first terminal is the first-type terminal. The first-type terminal includes at least one of an RSU, a terminal requiring relative location information of another controlled device, or a terminal matched with an interactive input device.

Optionally, the RSU needs to provide ranging and/or lateral information for another terminal. Optionally, the terminal requiring relative location information of another controlled device includes a programmable logic controller (PLC) used in production or the like. Optionally, the terminal matched with the interactive input device includes at least one of a smartphone, a tablet computer, an electronic book reader, a laptop computer, a desktop computer, a television, a game console, an augmented reality (AR) terminal, a virtual reality (VR) terminal, a mixed reality (MR) terminal, or the like. The interactive input device includes at least one of a handle, a wearable device, a prop, a controller, or the like. The terminal matched with the interactive input device requires location and/or angle information of the interactive input device.

In process 136, the first terminal sends the first-type SL-PRS or the second-type SL-PRS based on the first trigger signaling.

The first terminal sends the first-type SL-PRS or the second-type SL-PRS based on the first trigger signaling sent by the network device.

For example, the geographical location of the first terminal is in a zone without GNSS coverage and cellular network coverage that satisfies the positioning requirement. The first terminal reports the assistance information to the network device. The assistance information includes the geographical location information of the first terminal. The network device makes a decision based on the assistance information and then sends the first trigger signaling to the first terminal. The first trigger signaling is the first configuration information, or the first trigger signaling carries the first configuration information. The first terminal sends the first-type SL-PRS or the second-type SL-PRS based on the transmission resource and the transmission parameter in the first configuration information.

For example, the type of the first terminal is the first-type terminal. The first terminal reports the assistance information to the network device. The assistance information includes the type information of the first terminal. The network device makes a decision based on the assistance information and then sends the first trigger signaling to the first terminal. The first trigger signaling is the first configuration information, or the first trigger signaling carries the first configuration information. The first terminal sends the first-type SL-PRS or the second-type SL-PRS based on the transmission resource and the transmission parameter in the first configuration information.

In some embodiments, in the case that the type of the first terminal is the first-type terminal, the network device configures a dedicated SL-PRS transmission resource for the first terminal. Optionally, the first terminal continuously sends the SL-PRS before the network device reconfigures the SL-PRS transmission resource for the first terminal or before the network device cancels the configuration of the SL-PRS transmission resource for the first terminal.

In some embodiments, the first configuration information of the first-type SL-PRS and the first configuration information of the second-type SL-PRS from the network device are different.

Some embodiments for reporting request information to a network device are given as follows.

The present disclosure provides some embodiments of a method for sending a PRS. An example in which the method is applied to a terminal is used for description in these embodiments.

A first terminal sends request information to a network device. The network device sends a first trigger signaling to the first terminal based on the request information. The first terminal sends a first-type SL-PRS or a second-type SL-PRS based on the first trigger signaling.

In some embodiments, the request information includes first request information or second request information; or the request information includes first request information and second request information.

FIG. 14 is a schematic diagram of a method for sending a PRS according to some embodiments of the present disclosure. An example in which the method is applied to a terminal is used for description in these embodiments. The method includes at least one of the following processes.

In process 142, a first terminal sends first request information to a network device.

The first request information is used to request the network device to instruct the first terminal to send a first-type SL-PRS.

In some embodiments, the first terminal reports the first request information to the network device in the case that a geographical location of the first terminal falls within a target range. The target range includes a zone not covered by a GNSS and/or not covered by a cellular network that satisfies a positioning requirement.

In some embodiments, the first terminal reports the first request information to the network device in the case that the first terminal is a first-type terminal. The first-type terminal includes at least one of an RSU, a terminal requiring relative location information of another controlled device, or a terminal matched with an interactive input device.

Optionally, the RSU needs to provide ranging and/or lateral information for another terminal. Optionally, the terminal requiring relative location information of another controlled device includes a PLC used in production. Optionally, the terminal matched with the interactive input device includes at least one of a smartphone, a tablet computer, an electronic book reader, a laptop computer, a desktop computer, a television, a game console, an AR terminal, a VR terminal, an MR terminal, or the like. The interactive input device includes at least one of a handle, a wearable device, a prop, a controller, or the like. The terminal matched with the interactive input device requires location and/or angle information of the interactive input device.

In process 144, the network device sends a first trigger signaling to the first terminal.

The network device sends the first trigger signaling to the first terminal based on the first request information from the first terminal.

In some embodiments, the first trigger signaling is indicated explicitly, such as first configuration information. The first configuration information is used to configure at least one of a transmission resource or a transmission parameter of the first-type SL-PRS.

In some embodiments, the first trigger signaling is indicated implicitly. For example, the first trigger signaling further carries first configuration information. The first configuration information is used to configure at least one of a transmission resource or a transmission parameter of the first-type SL-PRS.

In process 146, the first terminal sends the first-type SL-PRS.

The first terminal sends the first-type SL-PRS based on the first trigger signaling sent by the network device.

For example, the geographical location of the first terminal is in a zone without GNSS coverage and cellular network coverage that satisfies the positioning requirement. The first terminal reports the first request information to the network device. The network device sends the first trigger signaling to the first terminal based on the first request information. The first trigger signaling is the first configuration information, or the first trigger signaling carries the first configuration information. The first terminal sends the first-type SL-PRS based on the transmission resource and the transmission parameter in the first configuration information.

For example, the type of the first terminal is the first-type terminal. The first terminal reports the first request information to the network device. The network device sends the first trigger signaling to the first terminal based on the first request information. The first trigger signaling is the first configuration information, or the first trigger signaling carries the first configuration information. The first terminal sends the first-type SL-PRS based on the transmission resource and the transmission parameter in the first configuration information.

For example, the first terminal is an RSU. The first terminal needs to provide absolute positioning reference information for another terminal. A target receiving terminal of the SL-PRS knows an absolute geographical location of the first terminal. That is, the target receiving terminal determines absolute geographical location information of the first terminal by receiving the SL-PRS sent by the first terminal. The first terminal reports the first request information to the network device. The network device sends the first trigger signaling to the first terminal based on the first request information. The first trigger signaling is the first configuration information, or the first trigger signaling carries the first configuration information. The first configuration information includes an SL-PRS transmission resource dedicated to the first terminal or another SL-PRS transmission mode configuration. The first terminal sends the first-type SL-PRS based on the first configuration information.

Optionally, the network device configures one or more first-type SL-PRS transmission resources for the first terminal. The first terminal uses all or at least one of the transmission resources to send the first-type SL-PRS.

In some embodiments, in the case that the type of the first terminal is the first-type terminal, the network device configures a dedicated SL-PRS transmission resource for the first terminal. Optionally, the first terminal continuously sends the SL-PRS before the network device reconfigures the SL-PRS transmission resource for the first terminal or before the network device cancels the configuration of the SL-PRS transmission resource for the first terminal.

FIG. 15 is a schematic diagram of a method for sending a PRS according to some embodiments of the present disclosure. An example in which the method is applied to a terminal is used for description in these embodiments. The method includes at least one of the following processes.

In process 152, a first terminal sends second request information to a network device.

The second request information is used to request the network device to instruct the first terminal to send a second-type SL-PRS.

In some embodiments, the first terminal reports the second request information to the network device in the case that a geographical location of the first terminal falls within a target range. The target range includes a zone not covered by a GNSS and/or not covered by a cellular network that satisfies a positioning requirement.

In some embodiments, the first terminal reports the second request information to the network device in the case that the first terminal is a first-type terminal. The first-type terminal includes at least one of an RSU, a terminal requiring relative location information of another controlled device, or a terminal matched with an interactive input device.

Optionally, the RSU needs to provide ranging and/or lateral information for another terminal. Optionally, the terminal requiring relative location information of another controlled device includes a PLC used in production. Optionally, the terminal matched with the interactive input device includes at least one of a smartphone, a tablet computer, an electronic book reader, a laptop computer, a desktop computer, a television, a game console, an AR terminal, a VR terminal, an MR terminal, or the like. The interactive input device includes at least one of a handle, a wearable device, a prop, a controller, or the like. The terminal matched with the interactive input device needs to obtain location and/or angle information of the interactive input device.

In process 154, the network device sends a first trigger signaling to the first terminal.

The network device sends the first trigger signaling to the first terminal based on the second request information from the first terminal.

In some embodiments, the first trigger signaling is indicated explicitly, such as first configuration information. The first configuration information is used to configure at least one of a transmission resource or a transmission parameter of the second-type SL-PRS.

In some embodiments, the first trigger signaling is indicated implicitly. For example, the first trigger signaling further carries first configuration information. The first configuration information is used to configure at least one of a transmission resource or a transmission parameter of the second-type SL-PRS.

In process 156, the first terminal sends the second-type SL-PRS.

The first terminal sends the second-type SL-PRS based on the first trigger signaling sent by the network device.

For example, the geographical location of the first terminal is in a zone without GNSS coverage and cellular network coverage that satisfies the positioning requirement. The first terminal reports the second request information to the network device. The network device sends the first trigger signaling to the first terminal based on the second request information. The first trigger signaling is the first configuration information, or the first trigger signaling carries the first configuration information. The first terminal sends the second-type SL-PRS based on the transmission resource and the transmission parameter in the first configuration information.

For example, the first terminal is the first-type terminal. The first terminal reports the second request information to the network device. The network device sends the first trigger signaling to the first terminal based on the second request information. The first trigger signaling is the first configuration information, or the first trigger signaling carries the first configuration information. The first terminal sends the second-type SL-PRS based on the transmission resource and the transmission parameter in the first configuration information.

For example, the first terminal has accurate geographical location information. The first terminal needs to provide absolute positioning reference information for another terminal. A target receiving terminal of the SL-PRS does not know an absolute geographical location of the first terminal. That is, the SL-PRS sent by the first terminal needs to be associated with information indicating the absolute geographical location of the first terminal and sent by the first terminal. The first terminal reports the second request information to the network device. The network device sends the first trigger signaling to the first terminal based on the second request information. The first trigger signaling is the first configuration information, or the first trigger signaling carries the first configuration information. The first configuration information includes an SL-PRS transmission resource dedicated to the first terminal or another SL-PRS transmission mode configuration. The first terminal sends the second-type SL-PRS based on the first configuration information.

Optionally, the network device configures one or more second-type SL-PRS transmission resources for the first terminal. The first terminal uses all or at least one of the transmission resources to send the second-type SL-PRS.

In some embodiments, in the case that the first terminal is the first-type terminal, the network device configures a dedicated SL-PRS transmission resource for the first terminal. Optionally, the first terminal continuously sends the SL-PRS before the network device reconfigures the SL-PRS transmission resource for the first terminal or before the network device cancels the configuration of the SL-PRS transmission resource for the first terminal.

Some embodiments for stopping sending a first-type SL-PRS or a second-type SL-PRS in the case that the first-type SL-PRS or the second-type SL-PRS is sent based on a trigger of a network device are given as follows.

FIG. 16 is a schematic diagram of a method for sending a PRS according to some embodiments of the present disclosure. An example in which the method is applied to a terminal is used for description in these embodiments. The method includes at least one of the following processes.

In process 162, a network device sends a second trigger signaling to a first terminal.

The second trigger signaling is used to trigger the first terminal to stop sending a first-type SL-PRS or a second-type SL-PRS.

In process 164, the first terminal stops sending the first-type SL-PRS or the second-type SL-PRS based on the second trigger signaling.

For example, if the network device determines, based on assistance information reported by the first terminal, that the first terminal does not need to send the SL-PRS, the network device sends the second trigger signaling to the first terminal, and the first terminal stops sending the first-type SL-PRS or the second-type SL-PRS.

For example, in the case that the first terminal reports third request information to the network device, the network device sends the second trigger signaling to the first terminal, and the first terminal stops sending the first-type SL-PRS or the second-type SL-PRS. The third request information is used to request the network device to instruct the first terminal to stop sending the first-type SL-PRS or the second-type SL-PRS, and is sent by the first terminal to the network device.

The present disclosure provides some embodiments of a method for sending a PRS. An example in which the method is applied to a terminal is used for description in these embodiments.

A first terminal stops sending a first-type SL-PRS or a second-type SL-PRS in the case that a stopping condition is satisfied and the first-type SL-PRS or the second-type SL-PRS is sent based on a trigger of a network device. The stopping condition includes that the first terminal is beyond a valid geographical range and/or the first trigger signaling exceeds a validity period.

In some embodiments, the valid geographical range is configured by the network device, configured by an RSU, preconfigured, or deined in a standard. For example, the valid geographical range is a zone covered by a GNSS and/or covered by a cellular network.

In some embodiments, the validity period is configured by the network device, configured by an RSU, preconfigured, or defined in a standard.

For example, the network device sends the first trigger signaling to the first terminal. The first trigger signaling is first configuration information, or the first trigger signaling carries first configuration information. The first configuration information includes information indicating the valid geographical range of the first trigger signaling. If the first terminal is beyond the valid geographical range, the first terminal stops sending the first-type SL-PRS or the second-type SL-PRS.

For example, the network device sends the first trigger signaling to the first terminal. The first trigger signaling is first configuration information, or the first trigger signaling carries first configuration information. The first configuration information includes information indicating the validity period of the first trigger signaling. If the first trigger signaling exceeds the validity period, the first terminal stops sending the first-type SL-PRS or the second-type SL-PRS. Optionally, the validity period is infinite.

For example, the network device sends the first trigger signaling to the first terminal. The first terminal stops sending the first-type SL-PRS or the second-type SL-PRS in the case that the first terminal is able to obtain accurate geographical location information.

Type 2: A first-type SL-PRS or a second-type SL-PRS is sent based on a trigger of an SL.

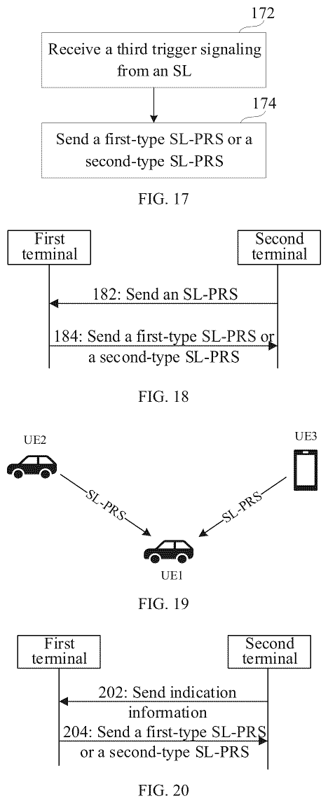

FIG. 17 is a schematic diagram of a method for sending a PRS according to some embodiments of the present disclosure. An example in which the method is applied to a terminal is used for description in these embodiments. The method includes at least one of the following processes:

In process 172, a first terminal receives a third trigger signaling from an SL.

The third trigger signaling is signaling used to trigger the first terminal to send a first-type SL-PRS or the second-type SL-PRS, and is sent by a second terminal to the first terminal over the SL.

In process 174, the first terminal sends the first-type SL-PRS or the second-type SL-PRS.

The first terminal sends the first-type SL-PRS or the second-type SL-PRS based on the third trigger signaling from the SL.

In some embodiments, the first terminal sends the first-type SL-PRS or the second-type SL-PRS; or the first terminal sends both the first-type and second-type SL-PRSs.

In summary, the terminal sends different PRSs based on the trigger of the SL in the method according to these embodiments, which reduces dependence on a network device during SL communication, satisfies positioning requirements under different conditions, and improves positioning accuracy and timeliness on the SL.

Some embodiments for receiving an SL-PRS sent by a second terminal are given as follows.

FIG. 18 is a schematic diagram of a method for sending a PRS according to some embodiments of the present disclosure. An example in which the method is applied to a terminal is used for description in these embodiments. The method includes at least one of the following processes.

In process 182, a second terminal sends a first-type SL-PRS or a second-type SL-PRS.

The second terminal is one of an RSU, a vehicle-mounted terminal, a handheld terminal, or the like. The second terminal sends the SL-PRS over an SL.

In some embodiments, the SL-PRS sent by the second terminal is a first-type SL-PRS or a second-type SL-PRS.

In process 184, a first terminal sends a first-type SL-PRS or a second-type SL-PRS to the second terminal.

In some embodiments, the first terminal receives the first-type SL-PRS sent by the second terminal and sends the first-type SL-PRS or the second-type SL-PRS to the second terminal.

In some embodiments, the first terminal receives the second-type SL-PRS sent by the second terminal and sends the first-type SL-PRS or the second-type SL-PRS to the second terminal.

In some embodiments, the first terminal sends the first-type SL-PRS or the second-type SL-PRS to the second terminal in the case that the first terminal receives the first-type SL-PRS sent by the second terminal and a received signal quality of the SL-PRS is higher than a first threshold, for example, a reference signal received power (RSRP) of the SL-PRS is higher than the first threshold. Optionally, a transmission resource used by the first terminal to send the first-type SL-PRS or the second-type SL-PRS to the second terminal is associated with a transmission resource used by the second terminal to send the first-type SL-PRS.

In some embodiments, the first threshold is configured by a network device, configured by an RSU, preconfigured, or defined in a standard.

In some embodiments, the first terminal sends the first-type SL-PRS or the second-type SL-PRS to the second terminal in the case that the first terminal receives the second-type SL-PRS sent by the second terminal and a received signal quality of the SL-PRS is higher than a second threshold, for example, an RSRP of the SL-PRS is higher than the second threshold. Optionally, a transmission resource used by the first terminal to send the first-type SL-PRS or the second-type SL-PRS to the second terminal is associated with a transmission resource used by the second terminal to send the second-type SL-PRS.

In some embodiments, the second threshold is configured by the network device, configured by the RSU, preconfigured, or defined in the standard.

In some embodiments, the first terminal sends the first-type SL-PRS or the second-type SL-PRS; or the first terminal sends both the first-type and second-type SL-PRSs.

For example, the second terminal sends the first-type SL-PRS or the second-type SL-PRS. The first terminal receives the first-type SL-PRS or the second-type SL-PRS sent by the second terminal and sends the first-type SL-PRS or the second-type SL-PRS to the second terminal.

For example, the second terminal sends the first-type SL-PRS or the second-type SL-PRS. The first terminal receives the first-type SL-PRS or the second-type SL-PRS sent by the second terminal, and sends the first-type SL-PRS or the second-type SL-PRS to the second terminal if the RSRP of the first-type SL-PRS or the second-type SL-PRS is higher than the first threshold or the second threshold.

For example, as shown in FIG. 19, UE2 and UE3 each send a first-type SL-PRS used for relative positioning over an SL. UE1 receives the first-type SL-PRS from each of UE2 and UE3. UE1 sends a first-type SL-PRS on a corresponding SL-PRS transmission resource. That is, UE1 sends the first-type SL-PRS to UE2 over a transmission resource associated with a transmission resource used by UE2 to send the first-type SL-PRS, and UE1 sends the first-type SL-PRS to UE3 over a transmission resource associated with a transmission resource used by UE3 to send the first-type SL-PRS. In this way, UE2 and UE3 each determines its distance from UE1 based on the first-type SL-PRS sent by UE1.

Some embodiments for receiving indication information sent by a second terminal are given as follows.

FIG. 20 is a schematic diagram of a method for sending a PRS according to some embodiments of the present disclosure. An example in which the method is applied to a terminal is used for description in these embodiments. The method includes at least one of the following processes.

In process 202, a second terminal sends indication information.

The second terminal sends the indication information in a broadcast, multicast, or unicast mode. The indication information is physical layer information, media access control (MAC) layer information, or PC5-radio resource control (RRC) information.

In some embodiments, the indication information includes first indication information or second indication information; or the indication information includes first indication information and second indication information.

The first indication information is information instructing a first terminal to send a first-type SL-PRS. The second indication information is information instructing the first terminal to send a second-type SL-PRS. In some embodiments, the second terminal periodically sends the indication information. Optionally, the period is fixed, configured by a network device, autonomously determined by the second terminal, or configured by an SL.

In some embodiments, the indication information is a discovery message or a message carrying basic security information.

In process 204, the first terminal sends the first-type SL-PRS or the second-type SL-PRS to the second terminal.

In some embodiments, the second terminal sends the indication information. The first terminal receives the indication information and sends the first-type SL-PRS or the second-type SL-PRS to the second terminal.

In some embodiments, the second terminal sends a PSCCH/PSSCH associated with a second-type SL-PRS. The PSCCH/PSSCH message includes the indication information. The first terminal sends the first-type SL-PRS or the second-type SL-PRS to the second terminal.

In some embodiments, the second terminal sends the indication information. The first terminal receives the indication information and measures a received signal quality of the indication information. If the measured received signal quality is higher than a first threshold (for example, an RSRP is higher than the first threshold), the first terminal sends the first-type SL-PRS to the second terminal.

In some embodiments, the second terminal sends the indication information. The first terminal receives the indication information and measures a received signal quality of the indication information. If the measured received signal quality is higher than a second threshold (for example, an RSRP is higher than the second threshold), the first terminal sends the second-type SL-PRS to the second terminal.

In some embodiments, the second terminal sends a PSCCH/PSSCH associated with a second-type SL-PRS. The PSCCH/PSSCH message includes the indication information. The first terminal receives the indication information and measures a received signal quality of the PSCCH/PSSCH message or the indication information. If the measured received signal quality is higher than the first threshold (for example, an RSRP is higher than the first threshold), the first terminal sends the first-type SL-PRS to the second terminal.

In some embodiments, the second terminal sends a PSCCH/PSSCH associated with a second-type SL-PRS. The PSCCH/PSSCH message includes the indication information. The first terminal receives the indication information and measures a received signal quality of the PSCCH/PSSCH message or the indication information. If the measured received signal quality is higher than the second threshold (for example, an RSRP is higher than the second threshold), the first terminal sends the second-type SL-PRS to the second terminal.

In some embodiments, the first threshold and/or the second threshold are configured by the network device, configured by an RSU, preconfigured, or defined in a standard.

In some embodiments, the second terminal sends a PSCCH/PSSCH associated with a second-type SL-PRS. The PSCCH/PSSCH message includes the indication information. The indication information includes identifiers (IDs) of one or more zones. The first terminal receives the indication information. In the case that a geographical location of the first terminal is in at least one of the zones indicated in the indication information, the first terminal sends the first-type SL-PRS or the second-type SL-PRS to the second terminal.

In some embodiments, a zone parameter, such as a length or a width, is configured by the network device, preconfigured, configured by the RSU, or defined in the standard. Optionally, the zone length and width are the same. Optionally, the first terminal determines an ID of a zone in which it is located based on its geographical location and the zone length and width.

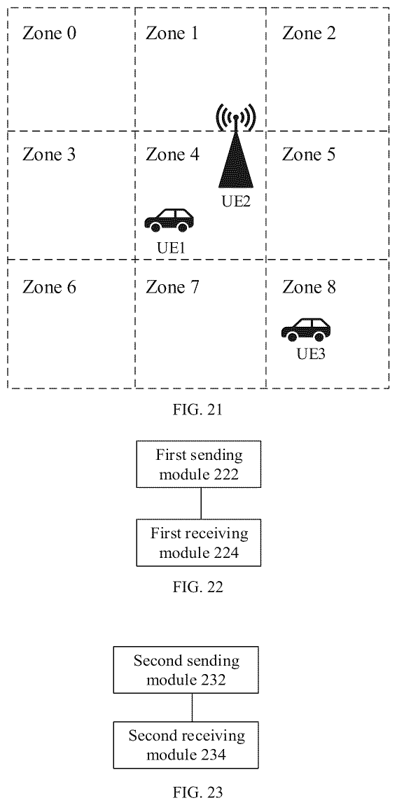

For example, as shown in FIG. 21, UE2 sends indication information. The indication information indicates only one zone whose ID is Zone 4. UE1 is located in Zone 4. UE3 is located in Zone 8. UE1 and UE3 both receive the indication information. Based on the indication information, only UE1 sends a first-type SL-PRS or a second-type SL-PRS to UE2. UE3 does not need to send a first-type SL-PRS or a second-type SL-PRS to UE2.

In some embodiments, the first terminal sends the first-type SL-PRS or the second-type SL-PRS; or the first terminal sends both the first-type and second-type SL-PRSs.

Some embodiments for stopping sending a first-type SL-PRS or a second-type SL-PRS in the case that the first-type SL-PRS or the second-type SL-PRS is sent based on a trigger of an SL are given as follows.

The present disclosure provides some embodiments of a method for sending a PRS. An example in which the method is applied to a terminal is used for description in these embodiments.

A first terminal sends a first-type SL-PRS or a second-type SL-PRS based on a trigger of an SL, and stops sending the first-type SL-PRS or the second-type SL-PRS in the case that a trigger condition is not satisfied.

The first terminal sends the first-type SL-PRS or the second-type SL-PRS based on the trigger of the SL. A second terminal sends a third trigger signaling to the first terminal continuously, periodically, or for a plurality of times through the SL. The first terminal stops sending the first-type SL-PRS or the second-type SL-PRS in the case that the third trigger signaling is not received from the SL, or if the third trigger signaling is received but the received signal quality of the third trigger signaling is lower than a threshold.

The first terminal sends the first-type SL-PRS or the second-type SL-PRS based on the trigger of the SL, and stops sending the first-type SL-PRS or the second-type SL-PRS in the case that fourth trigger signaling is received from the SL.

For example, the first terminal stops sending the first-type SL-PRS or the second-type SL-PRS in the case that the third trigger signaling is not received from the SL again within a target duration.

For example, the first terminal stops sending the first-type SL-PRS in the case that the third trigger signaling is received from the SL again within the target duration and the received signal quality of the third trigger signaling is lower than a first threshold (for example, an RSRP is lower than the first threshold).

For example, the first terminal stops sending the second-type SL-PRS in the case that the third trigger signaling is received from the SL again within the target duration and the received signal quality of the third trigger signaling is lower than a second threshold (for example, an RSRP is lower than the second threshold).

In some embodiments, the target duration is a duration calculated from a time the first terminal receives the third trigger signaling most recently, or the target duration is a duration calculated from a time the first terminal sends the SL-PRS most recently. Optionally, the target duration is configured by a network device, preconfigured, configured by an RSU, or defined in a standard.

For example, the first terminal receives the fourth trigger signaling from the SL and stops sending the first-type SL-PRS or the second-type SL-PRS. The fourth trigger signaling is used to trigger the first terminal to stop sending the first-type SL-PRS or the second-type SL-PRS, and is sent to the first terminal over the SL.

Type 3: A first-type SL-PRS or a second-type SL-PRS is sent based on an autonomous trigger.

The present disclosure provides some embodiments of a method for sending a PRS. An example in which the method is applied to a terminal is used for description in these embodiments.

A first terminal sends a first-type SL-PRS or a second-type SL-PRS in the case that a trigger condition is satisfied.

In some embodiments, the first terminal sends the first-type SL-PRS in the case that a first trigger condition is satisfied. The first trigger condition includes any one of the following conditions:
the first terminal is located in a first zone;
accuracy of geographical location information obtained from a positioning server (location management function (LMF)) is lower than a third threshold;
the first terminal does not have a GNSS reception capability, and the quantity of detected positioning reference points of the PRS is less than a fourth threshold; or
the first terminal has a GNSS reception capability and a quantity of detected positioning reference points of the PRS is less than a fifth threshold, and/or a strength of a received GNSS signal is less than a third threshold.

In some embodiments, the first zone is configured by a network device, preconfigured, configured by an RSU, or defined in a standard. Optionally, the zone length and width are the same. The first terminal determines an ID of a zone in which it is located based on its geographical location and the zone length and width.

In some embodiments, the third threshold is configured by the network device, preconfigured, configured by the RSU, or defined in the standard. Optionally, the third threshold includes at least one of a confidence level, a positioning error, or the like. Optionally, the accuracy of the geographical location information includes at least one of lateral, longitudinal, or vertical dimensions.

For example, the third threshold is configured by the network device, requiring the confidence level to be not lower than 95% and the positioning error to be less than 1 m. The first terminal obtains its geographical location information from the LMF. The accuracy of the geographical location information is lower than 95%. The positioning error is 0.5 m. The accuracy of the geographical location information is lower than the third threshold. The first terminal sends the first-type SL-PRS. In this way, the first terminal improves relative positioning accuracy by sending the first-type SL-PRS if its geographical location information obtained is not accurate enough.

In some embodiments, the fourth threshold is configured by the network device, preconfigured, configured by the RSU, or defined in the standard.

In some embodiments, a positioning reference point, also referred to as a reference point, is a device that sends a PRS for determining absolute location information. The device is a network device, a transmission/reception point (TRP), an RSU, a vehicle-mounted terminal, a handheld terminal, or the like.

For example, the fourth threshold is preconfigured, requiring the quantity of detected reference points to be not less than 3. The first terminal does not have the GNSS reception capability and detects only 2 reference points. The quantity of reference points that can be detected by the first terminal is less than the fourth threshold. The first terminal sends the first-type SL-PRS. In this way, the first terminal obtains relative positioning with another terminal by sending the first-type SL-PRS if the first terminal cannot know its absolute geographical location information.

In some embodiments, the fifth threshold is configured by the network device, preconfigured, configured by the RSU, or defined in the standard.

In some embodiments, the first terminal sends the second-type SL-PRS in the case that a second trigger condition is satisfied. The second trigger condition includes any one of the following conditions:
absolute geographical location information is obtained, and the accuracy of the geographical location information is higher than a sixth threshold;
absolute geographical location information is obtained, the accuracy of the geographical location information is higher than a sixth threshold, and the first terminal has an SL grant that satisfies a sending condition, wherein the sending condition is a condition for sending the PRS; or
absolute geographical location information is obtained, the accuracy of the geographical location information is higher than a sixth threshold, and the first terminal uses a GNSS as a reference synchronization source.

In some embodiments, the sixth threshold is configured by the network device, preconfigured, configured by the RSU, or defined in the standard. Optionally, the sixth threshold includes at least one of a confidence level, a positioning error, or the like. Optionally, the accuracy of the geographical location information includes at least one of lateral, longitudinal, or vertical dimensions.

For example, the sixth threshold is configured by the RSU, requiring the confidence level to be not lower than 95% and the positioning error to be less than 0.5 m. The first terminal obtains its geographical location information from the LMF. The accuracy of the geographical location information is higher than 95%. The positioning error is greater than 0.5 m. The accuracy of the geographical location information is higher than the sixth threshold. The first terminal sends the second-type SL-PRS. In this way, the first terminal provides an absolute positioning reference for another terminal if its geographical location information obtained is accurate.

In some embodiments, the SL grant that satisfies the sending condition means that a resource bandwidth, period, and quantity of resources in each period of the SL grant satisfy the sending condition. Optionally, the sending condition is configured by the network device, preconfigured, configured by the RSU, or defined in the standard.

In some embodiments, the sending condition includes at least one of the following conditions:
the resource bandwidth of the SL grant is not less than W subchannels;
the period of the SL grant is not greater than P; or
the quantity of resources in each period of the SL grant is not less than N.

Optionally, at least one of W, P, or N is configured by the network device, preconfigured, configured by the RSU, or defined in the standard.

For example, the network device configures the sending condition that the resource bandwidth of the SL grant is not less than W subchannels, the period is not greater than P. and the quantity of resources in each period is not less than N. and the sixth threshold is defined in the standard. The first terminal sends the second-type SL-PRS in the case that the accuracy of the geographical location information obtained by the first terminal is higher than the sixth threshold and the first terminal has the SL grant that satisfies the sending condition. In this way, the positioning performance of the SL-PRS can be ensured when the second-type SL-PRS is sent together with a PSSCH in the resource of the SL grant.

FIG. 22 is a structural block diagram of an apparatus for sending a PRS according to some embodiments of the present disclosure. The apparatus includes at least one of the following modules:
a first sending module 222 configured to send a first-type SL-PRS or a second-type SL-PRS, wherein the first-type SL-PRS is an SL-PRS separately sent, and the second-type SL-PRS is an SL-PRS associated with a PSCCH/PSSCH.

In an optional design, the apparatus further includes a first receiving module 224. The first receiving module 224 is configured to receive a first trigger signaling from a network device. The first sending module 222 is used to send the first-type SL-PRS or the second-type SL-PRS.

In an optional design, the first sending module 222 is configured to report assistance information to the network device. The assistance information is used to assist the network device in deciding whether to send the first trigger signaling.

In an optional design, the assistance information includes at least one of the following:
geographical location information of a first terminal; or
type information of the first terminal.

In an optional design, the first sending module 222 is configured to report request information to the network device. The request information is used to request the network device to instruct the first sending module 222 to send the first-type SL-PRS or the second-type SL-PRS.

In an optional design, in the case that a geographical location of the apparatus falls within a first target range, the first sending module 222 is configured to report the request information to the network device.

The first target range is a zone not covered by a GNSS and/or not covered by a cellular network that satisfies a positioning requirement.

In an optional design, in the case that the apparatus is a first-type terminal, the request information is reported to the network device.

The first-type terminal includes: at least one of an RSU, a terminal requiring relative location information of another controlled device, or a terminal matched with an interactive input device.

In an optional design, the first trigger signaling is indicated explicitly. The first receiving module 224 is configured to receive first configuration information from the network device. The first configuration information is used to configure at least one of a transmission resource or a transmission parameter of the SL-PRS.

In an optional design, the first trigger signaling is implicitly indicated by first configuration information. The first configuration information is used to configure at least one of a transmission resource or a transmission parameter of the SL-PRS.

In an optional design, the first receiving module 224 receives a second trigger signaling from the network device. The first sending module 222 stops sending the first-type SL-PRS or the second-type SL-PRS based on the second trigger signaling from the network device.

Alternatively, the first sending module 222 stops sending the first-type SLr-PRS or the second-type SL-PRS in the case that a stopping condition is satisfied. The stopping condition includes being beyond a valid geographical range and/or exceeding a validity period.

In an optional design, the first receiving module 224 receives a third trigger signaling from an SL. The first sending module 222 sends the first-type SL-PRS or the second-type SL-PRS based on the third trigger signaling from the SL.

In an optional design, the third trigger signaling includes an SL-PRS from a second terminal.

In an optional design, the first sending module 222 sends the first-type SL-PRS or the second-type SL-PRS in the case that the first receiving module 224 receives the first-type SL-PRS from the second terminal.

Alternatively, the first sending module 222 sends the first-type SL-PRS or the second-type SL-PRS in the case that the first receiving module 224 receives the second-type SL-PRS from the second terminal.

Alternatively, the first sending module 222 sends the first-type SL-PRS or the second-type SL-PRS in the case that the first receiving module 224 receives the first-type SL-PRS from the second terminal and a received signal quality of the SL-PRS is higher than a first threshold.

Alternatively, the first sending module 222 sends the first-type SL-PRS or the second-type SL-PRS in the case that the first receiving module 224 receives the second-type SL-PRS from the second terminal and a received signal quality of the SL-PRS is higher than a second threshold.

In an optional design, the first threshold is configured by a network device, configured by an RSU, preconfigured, or defined in a standard.

The second threshold is configured by the network device, configured by the RSU, preconfigured, or defined in the standard.

In an optional design, the second terminal sends indication information in a broadcast, multicast, or unicast mode.

In an optional design, the third trigger signaling is a discovery message or a message carrying basic security information.

In an optional design, the first sending module 222 sends the first-type SL-PRS or the second-type SL-PRS in the case that the first receiving module 224 receives the indication information from the second terminal and a received signal quality of the indication information is higher than a first threshold.

Alternatively, the first sending module 222 sends the first-type SL-PRS or the second-type SL-PRS in the case that the first receiving module 224 receives the indication information from the second terminal and the apparatus is located in a zone indicated by the indication information.

In an optional design, a parameter of the zone is configured by a network device, configured by an RSU, preconfigured, or defined in a standard.

In an optional design, the first sending module 222 stops sending the first-type SL-PRS or the second-type SL-PRS in the case that the first receiving module 224 does not receive the third trigger signaling from the SL again within a target duration.

Alternatively, the first sending module 222 stops sending the first-type SL-PRS in the case that the first receiving module 224 receives the third trigger signaling again within the target duration and a received signal quality of the third trigger signaling is lower than the first threshold.

Alternatively, the first sending module 222 stops sending the second-type SL-PRS in the case that the first receiving module 224 receives the third trigger signaling again within the target duration and the received signal quality of the third trigger signaling is lower than the second threshold.

Alternatively, the first sending module 222 stops sending the first-type SL-PRS or the second-type SL-PRS in the case that the first receiving module 224 receives a fourth trigger signaling from the SL.

The target duration is a duration calculated from a time at which the first receiving module 224 receives the third trigger signaling most recently, or the target duration is a duration calculated from a time at which the first sending module 222 sends the SL-PRS most recently.

In an optional design, the first sending module 222 sends the first-type SL-PRS or the second-type SL-PRS in the case that a trigger condition is satisfied.

In an optional design, the first sending module 222 sends the first-type SL-PRS in the case that a first trigger condition is satisfied.

The first sending module 222 sends the second-type SL-PRS in the case that a second trigger condition is satisfied.

In an optional design, the first trigger condition includes any one of the following conditions:
the apparatus is located in a first zone;
accuracy of geographical location information obtained by the first receiving module 224 from a positioning server is lower than a third threshold;
the first receiving module 224 does not have a GNSS reception capability, and the quantity of detected reference points of the PRS is less than a fourth threshold, wherein the reference points are devices that send a PRS for determining absolute location information; or
the first receiving module 224 has a GNSS reception capability, and the quantity of detected reference points of the PRS is less than a fifth threshold, wherein the reference points are devices that send a PRS for determining absolute location information.

In an optional design, the second trigger condition includes any one of the following conditions:
the first receiving module 224 obtains absolute geographical location information and the accuracy of the geographical location information is higher than a sixth threshold;
the first receiving module 224 obtains absolute geographical location information, the accuracy of the geographical location information is higher than a sixth threshold, and the apparatus has an SL grant that satisfies a sending condition, wherein the sending condition is a condition for sending the PRS; or
the first receiving module 224 obtains absolute geographical location information, the accuracy of the geographical location information is higher than a sixth threshold, and the apparatus uses a GNSS as a reference synchronization source.

In an optional design, the sending condition includes at least one of the following conditions:
a resource bandwidth of the SL grant is not less than W subchannels;
a period of the SL grant is not greater than P; or
a quantity of resources in each period of the SL grant is not less than N.

At least one of W, P, or N is configured by a network device, preconfigured, or defined in a standard.

In an optional design, the first sending module 222 stops sending the first-type SL-PRS or the second-type SL-PRS in the case that the trigger condition is not satisfied.

In an optional design, the first-type SL-PRS and the second-type SL-PRS use different transmission resources.

Alternatively, the first-type SL-PRS and the second-type SL-PRS correspond to different resource pools.

In an optional design, the first-type SL-PRS is used for relative positioning.

The second-type SL-PRS is used for absolute positioning.

FIG. 23 is a structural block diagram of an apparatus for sending a PRS according to some embodiments of the present disclosure. The apparatus includes at least one of the following modules:
a second sending module 232 configured to send a first trigger signaling to a first terminal, wherein the first trigger signaling is used to trigger the first terminal to send a first-type SL-PRS or a second-type SL-PRS.

In an optional design, the apparatus further includes a second receiving module 234 configured to receive assistance information reported by the first terminal. The assistance information is used to assist the apparatus in deciding whether to send the first trigger signaling.

In an optional design, the second sending module 232 sends the first trigger signaling to the first terminal in the case that the assistance information satisfies a trigger condition.

In an optional design, the assistance information includes geographical location information of the first terminal.

The second sending module 232 sends the first trigger signaling to the first terminal in the case that a geographical location of the first terminal falls within a first target range.

The first target range is a zone not covered by a GNSS and/or not covered by a cellular network that satisfies a positioning requirement.

In an optional design, the assistance information includes type information of the first terminal.

The second sending module 232 sends the first trigger signaling to the first terminal in the case that the first terminal is a first-type terminal.

The first-type terminal includes: at least one of an RSU, a terminal requiring relative location information of another controlled device, or a terminal matched with an interactive input device.

In an optional design, the second receiving module 234 is configured to receive request information reported by the first terminal. The request information is used to request the apparatus to instruct the first terminal to send the first-type SL-PRS or the second-type SL-PRS.

In an optional design, the request information reported by the first terminal is sent by the first terminal in the case that a geographical location of the first terminal falls within a first target range.

The first target range is a zone not covered by a GNSS and/or not covered by a cellular network that satisfies a positioning requirement.

In an optional design, the request information reported by the first terminal is sent by the first terminal in the case that the first terminal is a first-type terminal.

The first-type terminal includes at least one of an RSU, a terminal requiring relative location information of another controlled device, or a terminal matched with an interactive input device.

In an optional design, the first trigger signaling is indicated explicitly.

The second sending module 232 sends first configuration information to the first terminal. The first configuration information is used to configure at least one of a transmission resource or a transmission parameter of the SL-PRS.

In an optional design, the first trigger signaling is indicated implicitly.

The first trigger signaling further carries first configuration information. The first configuration information is used to configure at least one of a transmission resource or a transmission parameter of the SL-PRS.

In an optional design, the second sending module 232 sends a second trigger signaling to the first terminal. The second trigger signaling is used to trigger the first terminal to stop sending the first-type SL-PRS or the second-type SL-PRS.

In an optional design, the first-type SL-PRS and the second-type SL-PRS use different transmission resources.

Alternatively, the first-type SL-PRS and the second-type SL-PRS correspond to different resource pools.

In an optional design, the first-type SL-PRS is used for relative positioning.

The second-type SL-PRS is used for absolute positioning.

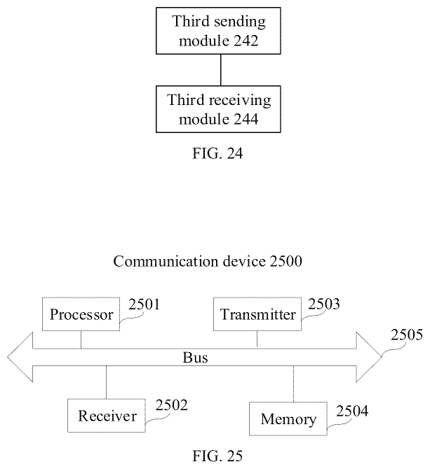

FIG. 24 is a structural block diagram of an apparatus for sending a PRS according to some embodiments of the present disclosure. The apparatus includes at least one of the following modules:
a third sending module 242 configured to send third trigger signaling, wherein the third trigger signaling is used to trigger a first terminal to send a first-type SL-PRS or a second-type SL-PRS.

In an optional design, the third sending module 242 sends the first-type SL-PRS.

Alternatively, the third sending module 242 sends the second-type SL-PRS.

In an optional design, the third sending module 242 sends the third trigger signaling in a broadcast, multicast, or unicast mode. The third trigger signaling carries indication information instructing the first terminal to send the first-type SL-PRS or the second-type SL-PRS.

In an optional design, the third trigger signaling is a discovery message or a message carrying basic security information.

In an optional design, the first-type SL-PRS and the second-type SL-PRS use different transmission resources.

Alternatively, the first-type SL-PRS and the second-type SL-PRS correspond to different resource pools.

In an optional design, the first-type SL-PRS is used for relative positioning.

The second-type SL-PRS is used for absolute positioning.

It should be noted that division into the foregoing function modules of the apparatus provided in the foregoing embodiments is merely used as an example. In practical application, the foregoing functions may be allocated to and completed by different function modules as required, that is, an internal structure of the apparatus is divided into different function modules to complete all or some of the foregoing functions.

Specific manners of performing operations by the modules in the apparatus in these embodiments have been described in detail in the embodiments of the related method, and details are not described herein again.

FIG. 25 is a schematic structural diagram of a communication device (terminal device or network device) according to some embodiments of the present disclosure. The communication device 2500 includes a processor 2501, a receiver 2502, a transmitter 2503, a memory 2504, and a bus 2505.

The processor 2501 includes one or more processing cores. The processor 2501 loads and runs a software program and module to execute various functional applications and information processing.

The receiver 2502 and the transmitter 2503 are implemented as a communication component. The communication component is a communication chip.

The memory 2504 is connected to the processor 2501 via the bus 2505. The memory 2504 is configured to store at least one instruction. The processor 2501 is configured to execute the at least one instruction to implement various processes in the foregoing method embodiments.

In addition, the memory 2504 is implemented by any type of transitory or non-transitory storage device or a combination thereof. The transitory or non-transitory storage device includes but is not limited to a magnetic disk or an optical disc, an electrically erasable programmable read-only memory (EEPROM), an erasable programmable read-only memory (EPROM), a static random access memory (SRAM), a read-only memory (ROM), a magnetic memory, a flash memory, or a programmable ROM (PROM).

In some embodiments, a computer-readable storage medium is further provided. The computer-readable storage medium stores at least one program. The at least one program, when loaded and executed by a processor, causes the processor to implement the method for sending a PRS provided in the foregoing method embodiments.

In some embodiments, a chip is further provided. The chip includes a programmable logic circuit and/or a program instruction. When running on a communication device, the chip is configured to implement the method for sending a PRS provided in the foregoing method embodiments.

In some embodiments, a computer program product is further provided. When running on a processor of a computer device, the computer program product enables the computer device to perform the foregoing method for sending a PRS.

In some embodiments, a communication system is further provided. The communication system includes the foregoing first terminal, second terminal, and network device, and is configured to implement the method for sending a PRS provided in the foregoing method embodiments.

A person skilled in the art should be aware that in the foregoing one or more examples, the functions described in the embodiments of the present disclosure may be implemented by hardware, software, firmware, or any combination thereof. When implemented by software, the functions may be stored in a computer-readable medium or transmitted as at least one instruction or code on the computer-readable medium. The computer-readable medium includes a computer storage medium and a communication medium. The communication medium includes any medium that facilitates transferring of a computer program from one place to another. The storage medium may be any usable medium accessible by a general-purpose computer or a special-purpose computer.

The foregoing descriptions are merely optional embodiments of the present disclosure and are not intended to limit the present disclosure. Any modification, equivalent replacement, and improvement within the spirit and principle of the present disclosure shall be included within the protection scope of the present disclosure.

1. A method for sending a positioning reference signal (PRS), applicable to a first terminal, the method comprising:
sending a first-type sidelink PRS (SL-PRS) or a second-type SL-PRS, wherein the first-type SL-PRS is an SL-PRS separately sent, and the second-type SL-PRS is an SL-PRS associated with a physical sidelink control channel (PSCCH)/physical sidelink shared channel (PSSCH).

2. The method according to claim 1, wherein sending the first-type SL-PRS or the second-type SL-PRS comprises:
sending the first-type SL-PRS or the second-type SL-PRS based on a first trigger signaling from a network device.

3. The method according to claim 2, wherein sending the first-type SL-PRS or the second-type SL-PRS comprises:
reporting request information to the network device, wherein the request information is used to request the network device to instruct the first terminal to send the first-type SL-PRS or the second-type SL-PRS.

4. The method according to claim 2, wherein the first trigger signaling is indicated explicitly, and the method further comprises:
receiving first configuration information from the network device, wherein the first configuration information is used to configure at least one of a transmission resource or a transmission parameter of the SL-PRS.

5. The method according to claim 1, wherein sending the first-type SL-PRS or the second-type SL-PRS comprises:
sending the first-type SL-PRS or the second-type SL-PRS based on a third trigger signaling from a sidelink (SL).

6. The method according to claim 5, wherein the third trigger signaling comprises:
an SL-PRS from a second terminal.

7. The method according to claim 5, wherein the third trigger signaling comprises:
indication information from a second terminal in a broadcast, multicast, or unicast mode.

8. The method according to claim 5, wherein sending the first-type SL-PRS or the second-type SL-PRS based on the third trigger signaling from the SL comprises:
sending the first-type SL-PRS or the second-type SL-PRS in a case that a PSCCH/PSSCH message associated with the second-type SL-PRS and the PSCCH/PSSCH message comprises indication information.

9. A first terminal, comprising:
a processor; and
a transceiver connected to the processor; and
a memory storing one or more instructions, which when executed by the processor, causes the first terminal to:
send a first-type sidelink PRS (SL-PRS) or a second-type SL-PRS, wherein the first-type SL-PRS is an SL-PRS separately sent, and the second-type SL-PRS is an SL-PRS associated with a physical sidelink control channel (PSCCH)/physical sidelink shared channel (PSSCH).

10. The first terminal according to claim 9, wherein the one or more instructions, which when executed by the processor, further causes the first terminal to:
send the first-type SL-PRS or the second-type SL-PRS based on a first trigger signaling from a network device.

11. The first terminal according to claim 10, wherein the one or more instructions, which when executed by the processor, further causes the first terminal to:
report request information to the network device, wherein the request information is used to request the network device to instruct the first terminal to send the first-type SL-PRS or the second-type SL-PRS.

12. The first terminal according to claim 10, wherein the first trigger signaling is indicated explicitly; and
wherein the one or more instructions, which when executed by the processor, further causes the first terminal to:
receive first configuration information from the network device, wherein the first configuration information is used to configure at least one of a transmission resource or a transmission parameter of the SL-PRS.

13. The first terminal according to claim 9, wherein the one or more instructions, which when executed by the processor, further causes the first terminal to:
send the first-type SL-PRS or the second-type SL-PRS based on a third trigger signaling from a sidelink (SL).

14. The first terminal according to claim 13, wherein the third trigger signaling comprises:
an SL-PRS from a second terminal.

15. The first terminal according to claim 13, wherein the third trigger signaling comprises:
indication information from a second terminal in a broadcast, multicast, or unicast mode.

16. The first terminal according to claim 13, wherein the one or more instructions, which when executed by the processor, further causes the first terminal to:
send the first-type SL-PRS or the second-type SL-PRS in a case that a PSCCH/PSSCH message associated with the second-type SL-PRS and the PSCCH/PSSCH message comprises indication information.

17. A network device, comprising:
a processor; and
a transceiver connected to the processor; and
a memory storing one or more instructions, which when executed by the processor, causes the network device to:
send a first trigger signaling to a first terminal, wherein the first trigger signaling is used to trigger the first terminal to send a first-type sidelink PRS (SL-PRS) or a second-type SL-PRS.

18. The network device according to claim 17, wherein the one or more instructions, which when executed by the processor, further causes the network device to:
receive assistance information reported by the first terminal, wherein the assistance information is used to assist the network device in deciding whether to send the first trigger signaling;
wherein sending the first trigger signaling to the first terminal comprises:
sending the first trigger signaling to the first terminal in a case that the assistance information satisfies a trigger condition.

19. The network device according to claim 17, wherein the one or more instructions, which when executed by the processor, further causes the network device to:
receive request information reported by the first terminal, wherein the request information is used to request the network device to instruct the first terminal to send the first-type SL-PRS or the second-type SL-PRS.

20. The network device according to claim 17, wherein the first trigger signaling is explicitly indicated; and
wherein the one or more instructions, which when executed by the processor, further causes the network device to:
send first configuration information to the first terminal, wherein the first configuration information is used to configure at least one of a transmission resource or a transmission parameter of the SL-PRS.
